(19) United States
(12) Patent Application Publication
(10) Pub. No.: US 2024/0034077 A1
(43) Pub. Date: Feb. 1, 2024

(54) PRINTING APPARATUS

(71) Applicant: SEIKO EPSON CORPORATION, Tokyo (JP)

(72) Inventors: Koji YAMADA, OKAYA-SHI (JP); Hiroyoshi OKADA, MATSUMOTO-SHI (JP); Kazuma OKI, SHIOJIRI-SHI (JP)

(21) Appl. No.: 18/358,739

(22) Filed: Jul. 25, 2023

(30) Foreign Application Priority Data
Jul. 29, 2022 (JP) 2022-121873

(51) Int. Cl. B41J 11/70

(52) U.S. Cl. CPC B41J 11/70

(57) ABSTRACT

A printing apparatus includes a rolled paper holder configured to accommodate rolled paper that is a roll of recording paper, a platen roller that feeds recording paper drawn from the rolled paper accommodated in the rolled paper holder toward an outlet, and a recess that extends in a second direction intersecting a first direction from the platen roller toward the outlet and provided between the platen roller and the outlet. The dimension of the recess in a third direction that is a depth direction of the recess is larger than the opening width of the recess in the first direction.

The present application is based on, and claims priority from JP Application Serial Number 2022-121873, filed Jul. 29, 2022, the disclosure of which is hereby incorporated by reference herein in its entirety.

### BACKGROUND

### 1. Technical Field

The present disclosure relates to a printing apparatus.

### 2. Related Art

As disclosed in JP-A-2011-136472, a printing apparatus including a platen roller that feeds recording paper drawn from roll-shaped recording paper accommodated in a paper holder toward an outlet is known.

In the printing apparatus in the related art, a problem may occur when the outlet is blocked by a user's hand or the like during printing. For example, recording paper obstructed from being discharged may wrap around the platen roller.

### SUMMARY

A printing apparatus according to an aspect of the present disclosure includes a rolled paper holder configured to accommodate rolled paper, a feeding roller that feeds recording paper drawn from the rolled paper accommodated in the rolled paper holder toward an outlet, and a recess that extends in a second direction intersecting a first direction from the feeding roller toward the outlet and provided between the feeding roller and the outlet. The dimension of the recess in a third direction that is a depth direction of the recess is larger than the opening width of the recess in the first direction.

### BRIEF DESCRIPTION OF THE DRAWINGS

FIG. 1 is a perspective view of a printing apparatus with an opening/closing cover thereof closed.

FIG. 2 is a perspective view of the printing apparatus with the opening/closing cover thereof open.

FIG. 3 is a sectional view of a printing apparatus according to a first embodiment.

FIG. 4 is a perspective view of a paper storage space forming member included in the printing apparatus according to the first embodiment.

FIG. 5 illustrates the paper storage space forming member included in the printing apparatus according to the first embodiment viewed from the +X direction side.

FIG. 6 illustrates recording paper stored in a recess included in the printing apparatus according to the first embodiment.

FIG. 7 is a sectional view of a printing apparatus according to a second embodiment.

FIG. 8 is a perspective view of a paper storage space forming member included in the printing apparatus according to the second embodiment.

FIG. 9 illustrates the paper storage space forming member included in the printing apparatus according to the second embodiment viewed from the +X direction side.

FIG. 10 illustrates recording paper stored in a recess included in the printing apparatus according to the second embodiment.

### DESCRIPTION OF EMBODIMENTS

### First Embodiment

Hereinafter, a printing apparatus 1 according to a first embodiment will be described with reference to the attached drawings. The printing apparatus 1 is used as, for example, a receipt printer. Note that, in the following description, directions based on an XYZ orthogonal coordinate system indicated in each figure will be used, but these directions are used only for convenience of description and do not limit the following embodiments.

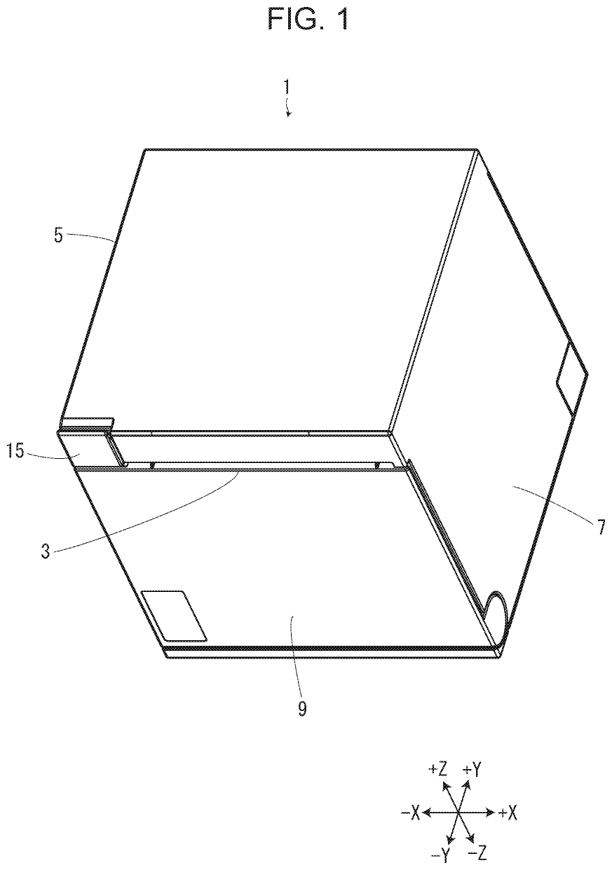

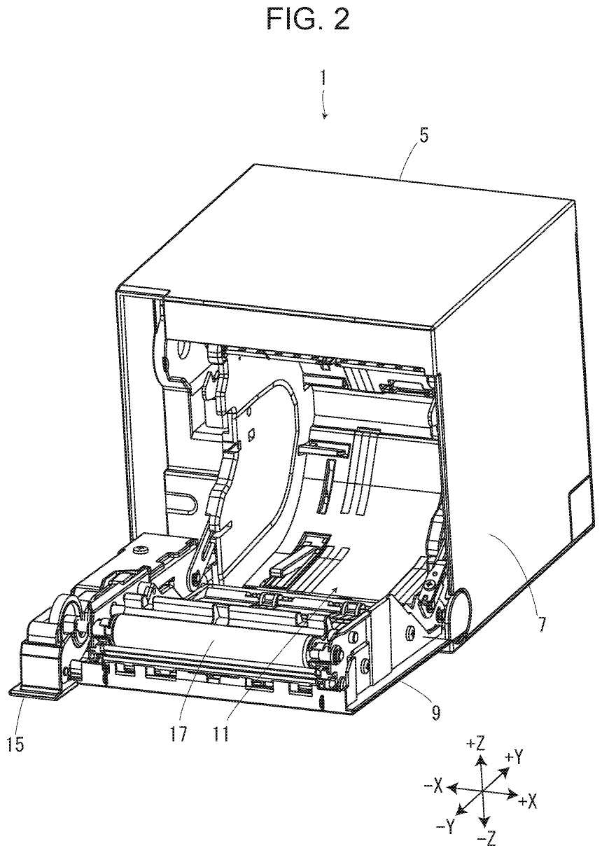

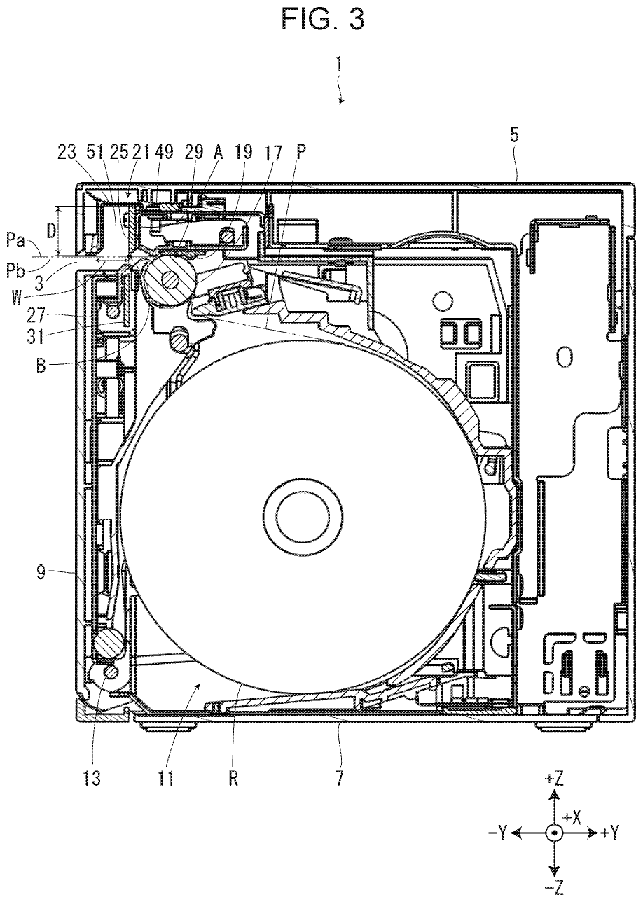

As illustrated in FIGS. 1 and 2, the printing apparatus 1 includes an apparatus case 5. The apparatus case 5 is formed in a substantially rectangular parallelepiped shape and constitutes an outer shell of the printing apparatus 1. The apparatus case 5 includes a case body 7 and an opening/closing cover 9. The case body 7 is formed in a substantially rectangular parallelepiped shape with one surface in the −Y direction open. A rolled paper holder 11 is provided in the case body 7. The rolled paper holder 11 can accommodate rolled paper R (see FIG. 3) that is a roll of recording paper P serving as a printing medium. The rolled paper R is placed into the rolled paper holder 11 by a drop-in method such that a rotation axis direction of the rolled paper R is parallel to the X direction.

The opening/closing cover 9 opens and closes the rolled paper holder 11. The opening/closing cover 9 is rotatably attached to a cover rotary shaft 13 (see FIG. 3). The cover rotary shaft 13 is provided at an end of the case body 7 in the −Z direction and extends in the X direction.

An outlet 3 is provided in a surface of the apparatus case 5 in the −Y direction. From the outlet 3, printed recording paper P is discharged. The outlet 3 is provided between a leading end of the opening/closing cover 9, that is, an end in the +Z direction, and the case body 7. The outlet 3 is formed in a substantially rectangular shape which is elongated in the X direction in the surface of the apparatus case 5 in the −Y direction. An edge of the outlet 3 is flush with an outer surface of the apparatus case 5, that is, the surface thereof in the −Y direction. In other words, in the surface of the apparatus case 5 in the −Y direction, the edge of the outlet 3 is not provided with a protrusion protruding outward from the apparatus case 5, that is, in the −Y direction.

In a surface of the case body 7 in the −Y direction, an opening lever 15 is provided at a corner in the −X direction and the +Z direction. A user can open the opening/closing cover 9 by operating the opening lever 15.

As illustrated in FIG. 3, the printing apparatus 1 includes a platen roller 17, a thermal head 19, a cutter 21, and a paper storage space forming member 23.

The platen roller 17 is provided on the inner side of the opening/closing cover 9 such that a rotation axis direction of the platen roller 17 is parallel to the X direction (see FIG. 2). The platen roller 17 is positioned further in the −Z direction than the thermal head 19 and faces the thermal head 19 with the opening/closing cover 9 closed. The platen roller 17 pinches the recording paper P with the thermal head 19 and rotates using a feeding motor (not illustrated) as a driving source to draw the recording paper P from the rolled paper R accommodated in the rolled paper holder 11 and feed the recording paper P toward the outlet 3 in the −Y direction. Note that, hereinafter, a position at which the platen roller 17 and the thermal head 19 pinch the recording paper P in a feeding path for the recording paper P from the rolled paper holder 11 to the outlet 3 is referred to as “pinching position A”. In addition, a direction from the pinching position A, that is, the platen roller 17, toward the outlet 3 is referred to as “first direction Y₋”.

The thermal head 19 is provided in the case body 7. The thermal head 19 includes a plurality of heating elements (not illustrated) and prints on the recording paper P drawn from the rolled paper R. Note that, of the front surface and the back surface of the recording paper P, a surface on which the thermal head 19 prints is referred to as “first surface Pa”, while a surface on the side opposite to the first surface Pa is referred to as “second surface Pb”.

The cutter 21 cuts the recording paper P in the X direction after printing is completed. Thus, the recording paper P is cut in the width direction of the recording paper P on the rear side of the printed portion of the recording paper P. A position at which the cutter 21 cuts the recording paper P in the feeding path for the recording paper P is referred to as “cutting position B”. The cutting position B is positioned between the pinching position A and the outlet 3. Note that the cutter 21 cuts the recording paper P while leaving a portion of the recording paper P in the width direction, for example, a substantially middle portion, so that the cut recording paper P remains in the outlet 3.

The cutter 21 includes a fixed blade 25 and a movable blade unit 27. The fixed blade 25 is fixed to a frame 29 provided in the case body 7. The movable blade unit 27 is provided on the inner side of the opening/closing cover 9. The movable blade unit 27 includes a movable blade 31 and a cutter motor (not illustrated). The movable blade 31 is positioned further in the −Z direction than the fixed blade 25 and faces the fixed blade 25 with the opening/closing cover 9 closed. The movable blade 31 is movable in the Z direction and moves toward the fixed blade 25 in the +Z direction to cut the recording paper P. The cutter motor is a driving source for the movable blade 31. Note that the fixed blade 25 may be referred to as “first blade”, while the movable blade 31 may be referred to as “second blade”.

The paper storage space forming member 23 is positioned between the pinching position A and the outlet 3, more specifically, between the cutting position B and the outlet 3, and is fixed to the frame 29 together with the fixed blade 25. The paper storage space forming member 23 is formed by, for example, bending a sheet metal and has a substantially inverted “L”-shaped cross-sectional shape when viewed from the +X direction side.

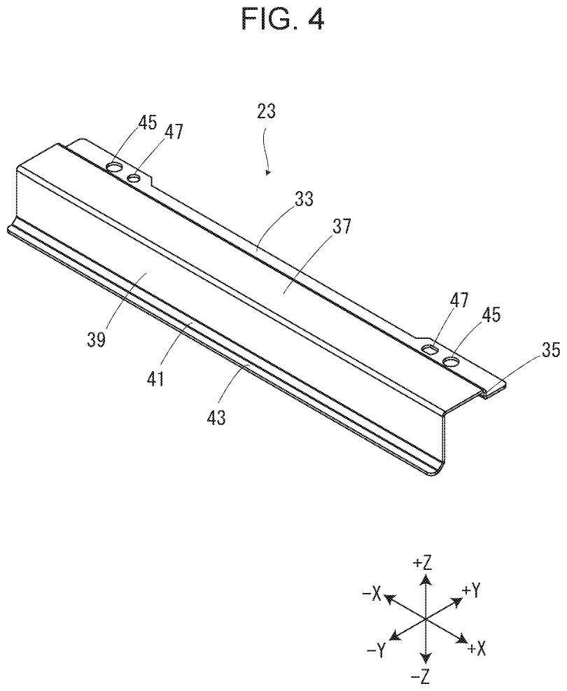

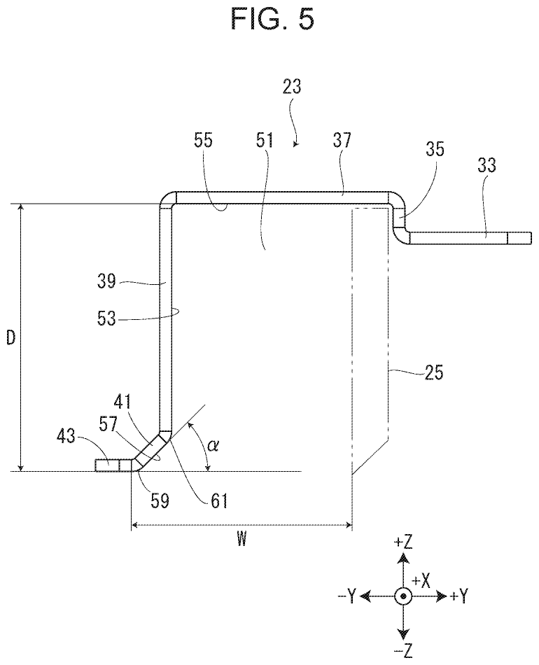

As illustrated in FIGS. 4 and 5, the paper storage space forming member 23 includes an A portion 33, a B portion 35, a C portion 37, a D portion 39, an E portion 41, and an F portion 43. The A portion 33 is positioned at an end of the paper storage space forming member 23 in the +Y direction and is formed in a substantially rectangular plate shape which is parallel to the XY plane and is elongated in the X direction. The A portion 33 is provided with two fixing holes 45 and two positioning holes 47, but the numbers thereof are not particularly limited thereto. The two fixing holes 45 are for fixing the paper storage space forming member 23 to the frame 29 with fixing screws 49 (see FIG. 3). The two positioning holes 47 are for positioning the paper storage space forming member 23 relative to the frame 29.

The B portion 35 extends in the +Z direction from an end of the A portion 33 in the −Y direction and is formed in a substantially rectangular plate shape which is parallel to the XZ plane and is elongated in the X direction. The C portion 37 extends in the −Y direction from an end of the B portion 35 in the +Z direction and is formed in a substantially rectangular plate shape which is parallel to the XY plane and is elongated in the X direction. The D portion 39 extends in the −Z direction from an end of the C portion 37 in the −Y direction and is formed in a substantially rectangular plate shape which is parallel to the XZ plane and is elongated in the X direction. The E portion 41 extends in an oblique direction between the −Y direction and the −Z direction from an end of the D portion 39 in the −Z direction and is formed in a substantially rectangular plate shape which obliquely intersects the XY plane and is elongated in the X direction. The F portion 43 extends in the −Y direction from an end of the E portion 41 in the −Y direction and the −Z direction and is formed in a substantially rectangular plate shape which is parallel to the XY plane and is elongated in the X direction.

The paper storage space forming member 23 configured in this way is fixed to the frame 29 such that the D portion 39 is positioned further in the −Y direction than the fixed blade 25 (see FIG. 3). Thus, a recess 51 is formed by the fixed blade 25 and the paper storage space forming member 23. Specifically, the fixed blade 25 forms a wall of the recess 51 in the +Y direction, the C portion 37 of the paper storage space forming member 23 forms a wall of the recess 51 in the +Z direction, and the D portion 39 and the E portion 41 form a wall of the recess 51 in the −Y direction. Note that the recess 51 is open in the +X direction, the −X direction, and the −Z direction.

The recess 51 faces the first surface Pa of the recording paper P that is fed toward the outlet 3 in the first direction Y₋ between the pinching position A and the outlet 3 (see FIG. 3). Specifically, of the case body 7 and the opening/closing cover 9, the recess 51 is provided in the case body 7, and is positioned further in the +Z direction than the recording paper P which is fed in the first direction Y₋ between the pinching position A and the outlet 3.

The recess 51 extends in a direction intersecting the first direction Y₋, that is, in the X direction. Note that the direction in which the recess 51 extends is referred to as “second direction X”. The dimension of the recess 51 in the second direction X is larger than the width of the recording paper P, that is, the dimension of the recording paper P in the second direction X. The recording paper P is fed in the first direction Y₋ between the pinching position A and the outlet 3 so as not to protrude from the recess 51 in the second direction X. Further, the dimension D of the recess 51 in the depth direction, that is, in the +Z direction, is larger than the opening width W of the recess 51 in the first direction Y₋. Note that the depth direction of the recess 51 is referred to as “third direction Z₊”.

The recess 51 includes a first inner surface 53, a third inner surface 55, and an edge inner surface 57. The first inner surface 53 is an inner surface of the D portion 39 and is positioned in the first direction Y₋ of the recess 51. The first inner surface 53 is parallel to the XZ plane. In other words, the first inner surface 53 is perpendicular to the first direction Y₋. The third inner surface 55 is an inner surface of the C portion 37 and is positioned in the third direction Z₊ of the recess 51. The third inner surface 55 is continuous with the first inner surface 53. The third inner surface 55 is parallel to the XY plane.

The edge inner surface 57 is an inner surface of the E portion 41 and is positioned at an opening edge of the recess 51, that is, an end of the recess 51 in the −Z direction. The edge inner surface 57 is continuous with the first inner surface 53. An end of the edge inner surface 57 in a fourth direction Z₋ opposite to the third direction Z₊, that is, in the −Z direction, is referred to as “front-side edge inner surface end 59”. On the other hand, an end of the edge inner surface 57 in the third direction Z₊, that is, the +Z direction, is referred to as “rear-side edge inner surface end 61”. The edge inner surface 57 is inclined with respect to the first direction Y₋ such that the front-side edge inner surface end 59 is positioned further in the first direction Y₋ than the rear-side edge inner surface end 61. In other words, the edge inner surface 57 extends in an oblique direction between the −Y direction and the −Z direction from an end of the first inner surface 53 in the −Z direction. The angle of inclination α of the edge inner surface 57 with respect to the first direction Y₋ is, for example, from 40 degrees to 50 degrees but is not particularly limited thereto.

Unlike the present embodiment, in a configuration in which the recess 51 is not provided between the pinching position A and the outlet 3, when the outlet 3 is blocked by a user's hand or the like during printing, a portion of the recording paper P obstructed from being discharged may enter a gap between the platen roller 17 and a member around the platen roller 17, resulting in a problem such as wrapping around the platen roller 17. When the recording paper P wraps around the platen roller 17, the load on the feeding motor that drives the platen roller 17 becomes excessive. Thus, the feeding motor stops, and the printing apparatus 1 enters an error state.

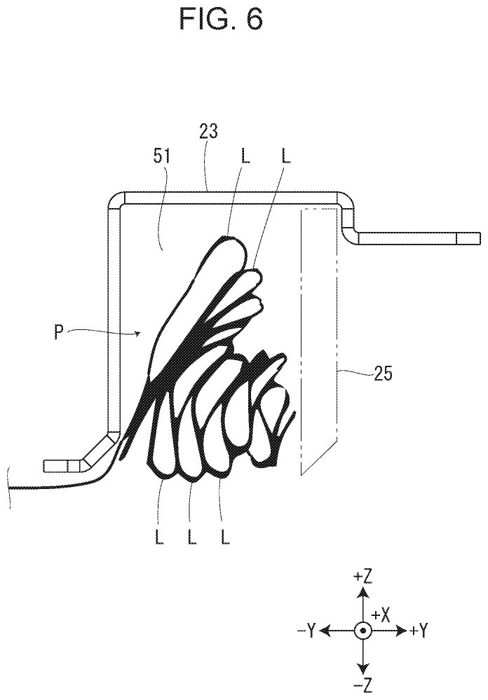

In contrast, in the present embodiment, since the recess 51 is provided between the pinching position A and the outlet 3, even when the outlet 3 is blocked during printing, after a leading end of the recording paper P comes into contact with an object blocking the outlet 3, a portion of the recording paper P enters the recess 51 from the −Z direction side, and the recording paper P is consequently deformed into a loop shape. Since the recording paper P is continuously fed by the platen roller 17 during printing, a plurality of loops L of the recording paper P are formed in the recess 51 one after another, and the recording paper P is folded in a bellows shape and is stored in the recess 51 (see FIG. 6). Here, as described above, since the dimension D of the recess 51 in the third direction Z₊ is larger than the opening width W of the recess 51 in the first direction Y₋, the loops L of the recording paper P are properly formed in the recess 51. Thus, when the outlet 3 is blocked during printing, the recess 51 functions as a space for storing the recording paper P folded in a bellows shape. Therefore, even when the outlet 3 is blocked during printing, the likelihood of the recording paper P wrapping around the platen roller 17 can be reduced.

The recording paper P stored in the recess 51 is cut by the cutter 21 after printing is completed. As described above, the recess 51 is provided between the outlet 3 and the cutting position B at which the cutter 21 cuts the recording paper P. Therefore, after the cutter 21 cuts the recording paper P, a user can pinch the leading end of the recording paper P exposed from the outlet 3 and can easily remove the recording paper P stored in the recess 51 from the outlet 3. Note that the volume of the recess 51 is, for example, a sufficient volume to store recording paper P with the maximum length assumed in one printing run but is not particularly limited thereto.

Further, before printing is started, the leading end of the recording paper P is positioned at the cutting position B. Once printing is started, the leading end of the recording paper P is fed from the cutting position B through the recess 51 to the outlet 3. At this time, when the leading end of the recording paper P is curved in the +Z direction, the leading end of the recording paper P may enter the recess 51.

In contrast, in the present embodiment, the recess 51 includes the edge inner surface 57 inclined with respect to the first direction Y₋. When the leading end of the recording paper P fed from the cutting position B comes into contact with the edge inner surface 57, the edge inner surface 57 guides the leading end of the recording paper P outside the recess 51, that is, in an oblique direction between the −Y direction and the −Z direction along the edge inner surface 57. Thus, the leading end of the recording paper P is fed to the outlet 3, and the likelihood of the leading end of the recording paper P entering the recess 51 can be reduced.

Note that, in the surface of the apparatus case 5 in the −Y direction, the edge of the outlet 3 can also be provided with a protrusion protruding outside the apparatus case 5 to store the recording paper P in a space surrounded by the protrusion. However, in the present embodiment, since the recess 51 capable of storing the recording paper P is provided in the apparatus case 5, the edge of the outlet 3 does not need to be provided with such a protrusion, and consequently a design in which the edge of the outlet 3 is flush with the outer surface of the apparatus case 5 can be realized.

### Second Embodiment

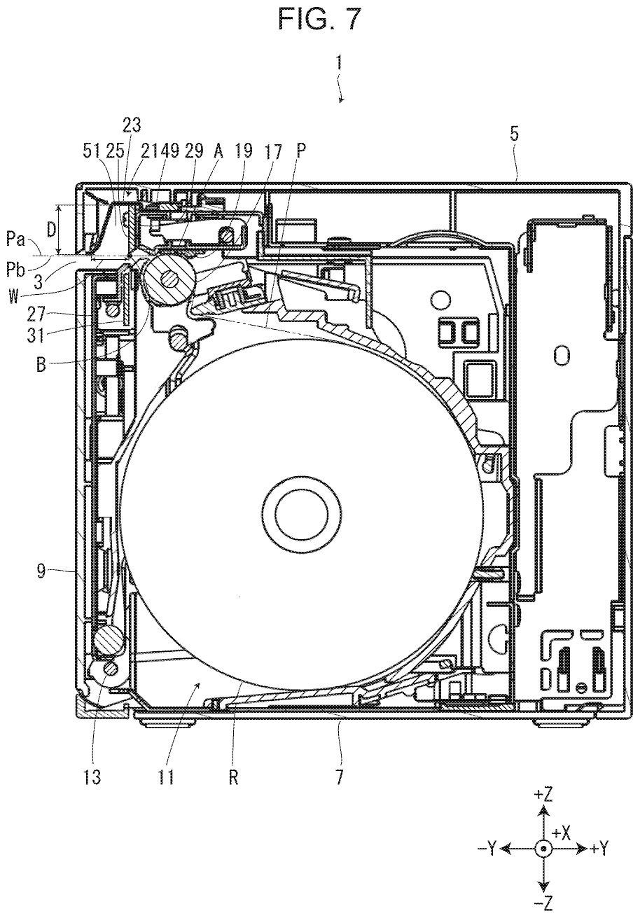

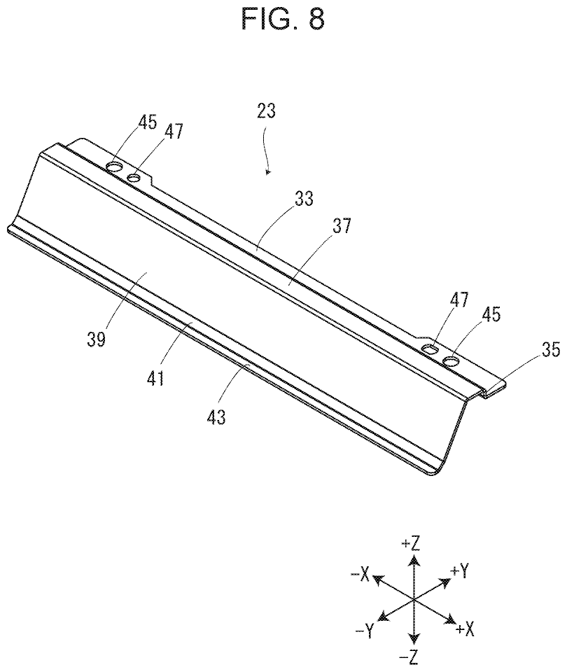

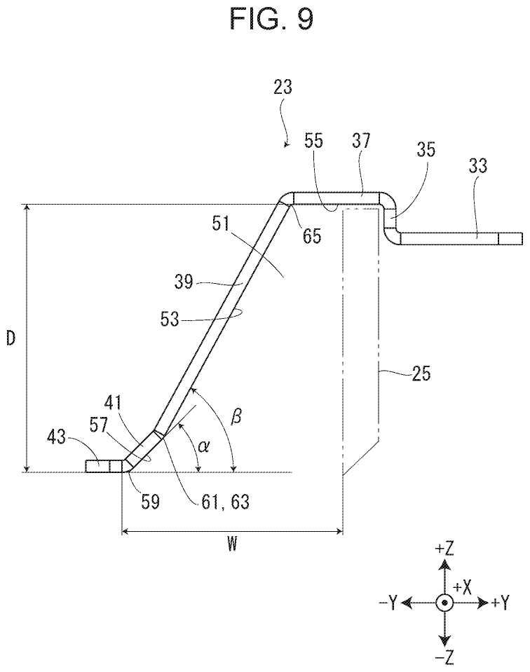

A printing apparatus 1 according to a second embodiment will be described with reference to FIGS. 7 to 10. The printing apparatus 1 according to the second embodiment has substantially the same configuration as the printing apparatus 1 according to the first embodiment but differs from the printing apparatus 1 according to the first embodiment in the shape of the paper storage space forming member 23. Hereinafter, mainly differences between the first embodiment and the second embodiment will be described.

As described above, in the paper storage space forming member 23 according to the first embodiment, the D portion 39 extends in the −Z direction from the end of the C portion 37 in the −Y direction and is formed in a substantially rectangular plate shape which is parallel to the XZ plane and is elongated in the X direction. In other words, the first inner surface 53 of the recess 51 is perpendicular to the first direction Y. In contrast, in the paper storage space forming member 23 according to the second embodiment, the D portion 39 extends in an oblique direction between the −Y direction and the −Z direction from the end of the C portion 37 in the −Y direction and is formed in a substantially rectangular plate shape which obliquely intersects the XY plane and is elongated in the X direction. In other words, the first inner surface 53 of the recess 51 is inclined with respect to the first direction Y₋ such that a front-side first inner surface end 63 is positioned further in the first direction Y₋ than a rear-side first inner surface end 65. Note that the front-side first inner surface end 63 refers to an end of the first inner surface 53 in the fourth direction Z₋. On the other hand, the rear-side first inner surface end 65 refers to an end of the first inner surface 53 in the third direction Z₊.

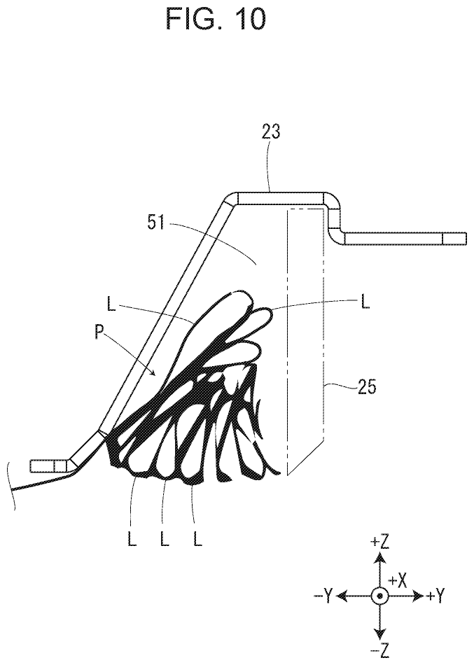

As described above, when the outlet 3 is blocked during printing, the loops L of the recording paper P are formed in the recess 51. The loops L are formed in a position following the first inner surface 53. In other words, in the first embodiment, since the first inner surface 53 is perpendicular to the first direction Y₋, the loops L formed in the recess 51 are substantially perpendicular to the first direction Y₋ (see FIG. 6). In contrast, in the second embodiment, since the first inner surface 53 is inclined with respect to the first direction Y₋, the loops L formed in the recess 51 are inclined with respect to the first direction Y₋ (see FIG. 10). When the loops L are inclined with respect to the first direction Y₋, the leading end of the recording paper P is less likely to be drawn into the apparatus case 5 from the outlet 3 than when the loops L are substantially perpendicular to the first direction Y₋. In other words, in the second embodiment, since the first inner surface 53 is inclined with respect to the first direction Y−, the loops L formed in the recess 51 are inclined with respect to the first direction Y₋. Consequently, the leading end of the recording paper P is less likely to be drawn into the apparatus case 5 from the outlet 3. Therefore, after the cutter 21 cuts the recording paper P, difficulties in removing the recording paper P stored in the recess 51 from the output 3 can be reduced.

Further, when the leading end of the recording paper P is drawn into the apparatus case 5 from the outlet 3 and it is difficult to remove the recording paper P stored in the recess 51 from the outlet 3, the opening/closing cover 9 needs to be opened to remove the recording paper P from the recess 51. When the opening/closing cover 9 is opened, the opening/closing cover 9 rotates about the cover rotary shaft 13 while pressing the recording paper P stored in the recess 51 between a member such as the platen roller 17 provided in the opening/closing cover 9 and the paper storage space forming member 23 provided in the case body 7.

In the first embodiment, since the first inner surface 53 is perpendicular to the first direction Y₋, a relatively large amount of recording paper P is stored in the recess 51 (see FIG. 6). When the opening/closing cover 9 is opened, the relatively large amount of recording paper P is pressed, thereby increasing the load in opening the opening/closing cover 9. Therefore, a user with weak strength may be unable to open the opening/closing cover 9.

In contrast, in the second embodiment, since the first inner surface 53 is inclined with respect to the first direction Y₋, a relatively small amount of recording paper P is stored in the recess 51 (see FIG. 10). When the opening/closing cover 9 is opened, the relatively small amount of recording paper P is pressed, thereby reducing the load in opening the opening/closing cover 9 compared with the first embodiment. Therefore, even a user with weak strength is able to readily open the opening/closing cover 9.

In this way, in the printing apparatus 1 according to the second embodiment, since the first inner surface 53 is inclined with respect to the first direction Y₋, the likelihood of the leading end of the recording paper P being drawn into the apparatus case 5 from the outlet 3 can be reduced, and the amount of recording paper P stored in the recess 51 can be reduced.

Further, in the printing apparatus 1 according to the second embodiment, since the recess 51 includes an edge inner surface 57 having a smaller angle of inclination with respect to the first direction Y₋ than the first inner surface 53, the leading end of the recording paper P is guided outside the recess 51 when the leading end of the recording paper P fed from the cutting position B comes into contact with the edge inner surface 57. Consequently, the likelihood of the leading end of the recording paper P entering the recess 51 can be reduced.

The angle of inclination β of the first inner surface 53 with respect to the first direction Y₋ is, for example, from 55 degrees to 65 degrees but is not particularly limited thereto. As the angle of inclination β of the first inner surface 53 is smaller, the leading end of the recording paper P is less likely to be drawn into the apparatus case 5 from the outlet 3. Consequently, the amount of recording paper P stored in the recess 51 is reduced. As the angle of inclination β of the first inner surface 53 is larger, the dimension of the recess 51 in the first direction Y₋ can be reduced. Further, the angle of inclination α of the edge inner surface 57 with respect to the first direction Y₋ is smaller than the angle of inclination β of the first inner surface 53 with respect to the first direction Y₋.

### Other Modifications

It is evident that the present disclosure is not limited to the above-described embodiments and that various configurations can be employed without departing from the spirit of the present disclosure. For example, in addition to the above-described embodiments, the following modifications can be made. Moreover, combinations of the embodiments and modifications may be used.

The recess 51 is not limited to a configuration in which the recess 51 is provided so as to face the first surface Pa of the recording paper P, and may be provided so as to face the second surface Pb of the recording paper P. Further, the recess 51 is not limited to a configuration in which, of the case body 7 and the opening/closing cover 9, the recess 51 is provided in the case body 7, and may be provided in the opening/closing cover 9.

The recess 51 is not limited to a configuration in which the recess 51 is formed by the fixed blade 25 and the paper storage space forming member 23, and may be formed by, for example, only the paper storage space forming member 23 or by a member other than the fixed blade 25 and the paper storage space forming member 23.

The cutter 21 is not limited to a configuration in which the cutter 21 is driven by a motor, and may be configured to be operated, for example, by a lever operation. In other words, the cutter 21 is not limited to a configuration in which an automatic cutter is used, and may be a manual cutter. Further, the cutter 21 is not limited to a configuration in which the recording paper P is cut while leaving a portion of the recording paper P in the width direction, and may be configured such that the recording paper P is completely cut in the width direction of the recording paper P.

The rolled paper holder 11 is not limited to a configuration in which the rolled paper R is placed by a drop-in method, and may include, for example, a support shaft that rotatably supports the rolled paper R.

A printing system used in the printing apparatus 1 is not limited to a thermal system and may be, for example, an ink jet system or an electrophotographic system.

### APPENDIX

Hereinafter, a printing apparatus will be additionally described. The printing apparatus includes a rolled paper holder configured to accommodate rolled paper that is a roll of recording paper, a feeding roller that feeds recording paper drawn from the rolled paper accommodated in the rolled paper holder toward an outlet, and a recess that extends in a second direction intersecting a first direction from the feeding roller toward the outlet and that faces one surface of the recording paper fed in the first direction between the feeding roller and the outlet. The dimension of the recess in a third direction that is a depth direction of the recess is larger than the opening width of the recess in the first direction.

According to this configuration, when the outlet is blocked during printing, recording paper folded in a bellows shape can be stored in the recess. Note that the platen roller 17 is an example of a feeding roller.

In this case, the recess may include a third inner surface positioned in the third direction of the recess and a first inner surface that is continuous with the third inner surface and that is positioned in the first direction of the recess. The first inner surface may be inclined with respect to the first direction such that a front-side first inner surface end that is an end of the first inner surface in a fourth direction opposite to the third direction is positioned further in the first direction than a rear-side first inner surface end that is an end of the first inner surface in the third direction.

According to this configuration, when the recording paper is folded in a bellows shape and stored in the recess, the likelihood of a leading end of the recording paper being drawn into the printing apparatus from the outlet can be reduced. Therefore, difficulties in removing the recording paper stored in the recess from the output can be reduced. Further, the amount of recording paper stored in the recess can be reduced.

In this case, the recess may include an edge inner surface that is continuous with the first inner surface and that is positioned at an opening edge of the recess. The edge inner surface may be inclined with respect to the first direction such that a front-side edge inner surface end that is an end of the edge inner surface in the fourth direction opposite to the third direction is positioned further in the first direction than a rear-side edge inner surface end that is an end of the edge inner surface in the third direction. An angle of inclination of the edge inner surface with respect to the first direction may be smaller than an angle of inclination of the first inner surface with respect to the first direction.

According to this configuration, when the leading end of the recording paper comes into contact with the edge inner surface, the leading end of the recording paper is guided outside the recess. Therefore, the likelihood of the leading end of the recording paper entering the recess can be reduced.

In this case, the recess may include a third inner surface positioned in the third direction of the recess, a first inner surface that is continuous with the third inner surface and that is positioned in the first direction of the recess, and an edge inner surface that is continuous with the first inner surface and that is positioned at an opening edge of the recess. The edge inner surface may be inclined with respect to the first direction such that a front-side edge inner surface end that is an end of the edge inner surface in a fourth direction opposite to the third direction is positioned further in the first direction than a rear-side edge inner surface end that is an end of the edge inner surface in the third direction.

According to this configuration, when the leading end of the recording paper comes into contact with the edge inner surface, the leading end of the recording paper is guided outside the recess. Therefore, the likelihood of the leading end of the recording paper entering the recess can be reduced.

In this case, the printing apparatus may further include an apparatus case provided with the outlet. An edge of the outlet may be flush with an outer surface of the apparatus case.

According to this configuration, since the recess capable of storing the recording paper is provided, an edge of the outlet does not need to be provided with a protrusion for storing the recording paper, and consequently a design in which the edge of the outlet is flush with an outer surface of the apparatus case can be realized.

In this case, the printing apparatus may further include a cutter for cutting the recording paper. The recess may be provided between a cutting position at which the cutter cuts the recording paper and the outlet.

According to this configuration, after the cutter cuts the recording paper, a user can pinch the leading end of the recording paper exposed from the outlet and can easily remove the recording paper stored in the recess from the outlet.

What is claimed is:

1. A printing apparatus comprising:
a rolled paper holder configured to accommodate rolled paper;
a feeding roller that feeds recording paper drawn from the rolled paper accommodated in the rolled paper holder toward an outlet; and
a recess that extends in a second direction intersecting a first direction from the feeding roller toward the outlet and provided between the feeding roller and the outlet, wherein
a dimension of the recess in a third direction that is a depth direction of the recess is larger than an opening width of the recess in the first direction.

2. The printing apparatus according to claim 1, wherein
the recess includes
a third inner surface positioned in the third direction of the recess and
a first inner surface that is continuous with the third inner surface and that is positioned in the first direction of the recess, and
the first inner surface is inclined with respect to the first direction such that a front-side first inner surface end that is an end of the first inner surface in a fourth direction opposite to the third direction is positioned further in the first direction than a rear-side first inner surface end that is an end of the first inner surface in the third direction.

3. The printing apparatus according to claim 2, wherein
the recess includes an edge inner surface that is continuous with the first inner surface and that is positioned at an opening edge of the recess,
the edge inner surface is inclined with respect to the first direction such that a front-side edge inner surface end that is an end of the edge inner surface in the fourth direction opposite to the third direction is positioned further in the first direction than a rear-side edge inner surface end that is an end of the edge inner surface in the third direction, and
an angle of inclination of the edge inner surface with respect to the first direction is smaller than an angle of inclination of the first inner surface with respect to the first direction.

4. The printing apparatus according to claim 1, wherein
the recess includes
a third inner surface positioned in the third direction of the recess,
a first inner surface that is continuous with the third inner surface and that is positioned in the first direction of the recess, and
an edge inner surface that is continuous with the first inner surface and that is positioned at an opening edge of the recess, and
the edge inner surface is inclined with respect to the first direction such that a front-side edge inner surface end that is an end of the edge inner surface in a fourth direction opposite to the third direction is positioned further in the first direction than a rear-side edge inner surface end that is an end of the edge inner surface in the third direction.

5. The printing apparatus according to claim 1,
further comprising:
an apparatus case provided with the outlet, wherein an edge of the outlet is flush with an outer surface of the apparatus case.

6. The printing apparatus according to claim 1, further comprising:
a cutter for cutting the recording paper, wherein
the recess is provided between a cutting position at which the cutter cuts the recording paper and the outlet.
